(19) United States
(12) Patent Application Publication
(10) Pub. No.: US 2022/0183212 A1
(43) Pub. Date: Jun. 16, 2022

(54) SUPPORT BEATER FOR AGRICULTURAL EQUIPMENT AND AGRICULTURAL EQUIPMENT

(71) Applicant: Marchesan Implementos e Máquinas Agrícolas Tatu S.A., Matao-SP (BR)

(72) Inventors: Sebastião Antonio Jacomine, Matao-SP (BR); Carlos Cesar Galhardi, Matao-SP (BR)

(21) Appl. No.: 17/552,610

(22) Filed: Dec. 16, 2021

(30) Foreign Application Priority Data
Dec. 16, 2020 (BR) 102020025773-0

(51) Int. Cl. A01B 76/00; A01B 73/04

(52) U.S. Cl. CPC A01B 76/00; A01B 73/048

(57) ABSTRACT

Presently described is a support stop (1) for agricultural equipment (2) comprising a support portion (10) to be secured on a first structural portion (20) of the agricultural equipment (2), and a portion of damping (11) configured to contact a second structural portion (21) of the agricultural equipment (2), allowing the structural portions to adequately support and absorb impacts that occur during the displacement of the equipment in the transport position. The present invention further relates to agricultural equipment provided with the aforementioned supporting stop.

### CROSS REFERENCE TO RELATED APPLICATIONS

This application claims priority to and the benefit of Brazilian Application No. 102020025773-0, filed Dec. 16, 2020; the contents of which as are hereby incorporated by reference in their entirety.

### BACKGROUND

### Technical Field

The present invention relates to a supporting stop for application in agricultural equipment, and particularly for application in agricultural equipment with structural portions that can be articulated with each other for configuration of work and transport positions, which allows the structural portions to have adequate support and absorption of impacts that occur during the displacement of the equipment in transport position. The present invention further relates to agricultural equipment provided with the aforementioned supporting stop.

### Description of Related Art

The growing demand for agricultural soil preparation equipment that operate at higher displacement speeds—16 to 24 km/h (compared to 06 to 12 km/h for usual equipment) has culminated in the use of equipment equipped with two parallel sections of concave discs, which stand out for being installed individually and resiliently together with a mounting bracket.

Equipment models with folding wing sections are common to obtain large working span and reduced transport width for transit on highways and countryside roads. An example of equipment of this type can be seen in patent document U.S. Pat. No. 9,936,621, which reveals a cultivator equipment equipped with provisions for closing its lateral and central sections on the equipment header, thus allowing reduced dimensions to carry out the equipment transportation, even during its movement in the field itself.

However, at the time of transforming the equipment from a working position to a transport position, its lateral and central sections are removed from their support on the ground and supported simultaneously on the equipment traction header. This means that the entire weight of the lateral and central sections of the equipment is dumped on the header, which must be sufficiently robust and flexible to absorb such weight.

However, even though the header itself is capable of bearing the backing of the equipment sections, the weight of these sections is inevitably still dumped on sensitive hydraulic components and particularly on the actuator cylinders that articulate the center wheels in relation to the center section of the equipment, which, during the transport position of the equipment, remain fully extended.

It was observed that, during its movement in transport configuration, and especially at the time of moving in the field, the equipment suffers bumps and vibrations resulting from the unevenness of the ground that render into direct impacts on the aforementioned actuator cylinder, which seriously damages its internal components and harm the hydraulic circuit as a whole. In extreme cases, the cylinder breaks are even observed, which can cause serious accidents and severe damage both to the equipment and its operators.

Therefore, there is no element in the state of the art capable of adequately supporting and absorbing impacts that occur on the structure of the equipment during its displacement in transport position.

### BRIEF SUMMARY

A first objective of the present invention is to provide a supporting stop applicable to agricultural equipment that allows adequate support between equipment structures and absorption of impacts resulting from the movement of the equipment during its transport configuration.

A second objective of the present invention is to provide a supporting stop applicable to agricultural equipment that is capable of preventing the efforts arising from bumps and vibrations during the transport configuration from acting directly on the hydraulic cylinders articulating the central wheels with the central section of the equipment without any type of mitigation.

The present invention deals with a supporting stop for agricultural equipment comprising a supporting portion to be secured on a first structural portion of agricultural equipment, and a damping portion configured to contact a second structural portion of agricultural equipment.

In one possible embodiment, the damping portion is configured to contact the second structural portion of the farm equipment at the time of configuring the farm equipment, for a transport position.

In another possible embodiment, the damping portion is disposed on the supporting portion.

In another possible embodiment, the supporting portion is secured on the header of the agricultural equipment.

The present invention further contemplates agricultural equipment comprising a first and a second structural portion, the first structural portion being provided with a supporting stop, the supporting stop comprising a supporting portion to be secured on a first structural portion of the agricultural equipment; and a damping portion configured to contact a second structural portion of the agricultural equipment.

In another possible embodiment, the agricultural equipment is configured to assume a working position and a transport position, the damping portion being configured to contact a second structural portion of the agricultural equipment at the time of the agricultural equipment assumes the transport position.

In another possible embodiment, the first structural portion is a header.

In another possible embodiment, the second structural portion is a central frame hingedly associated with the header.

### BRIEF DESCRIPTION OF THE FIGURES

The present invention will be described in more detail below, based on an example of execution shown in the drawings. The figures show:

FIG. 1—is a perspective view of the agricultural equipment of the present invention in a transport position, and provided with the supporting stop of the present invention in a configuration considered preferred;

FIG. 2—is a perspective view of the disc holder of the present FIG. 2—is a side view of the agricultural equipment of the present invention in a transport position, and provided with the supporting stop of the present invention in a configuration considered to be preferred;

FIG. 3—is a detail of the side view of FIG. 2;

FIG. 4—is a detail of a perspective view of the agricultural equipment of the present invention in a working position, and provided with the supporting stop of the present invention in a configuration considered preferred;

FIG. 5—is a detail of FIG. 4.

### DETAILED DESCRIPTION OF VARIOUS EMBODIMENTS

Initially, it should be noted that the term “preferred” used here should not be understood as imperative or mandatory, but rather to determine an embodiment of particular efficiency of the invention among the multiple possible ones.

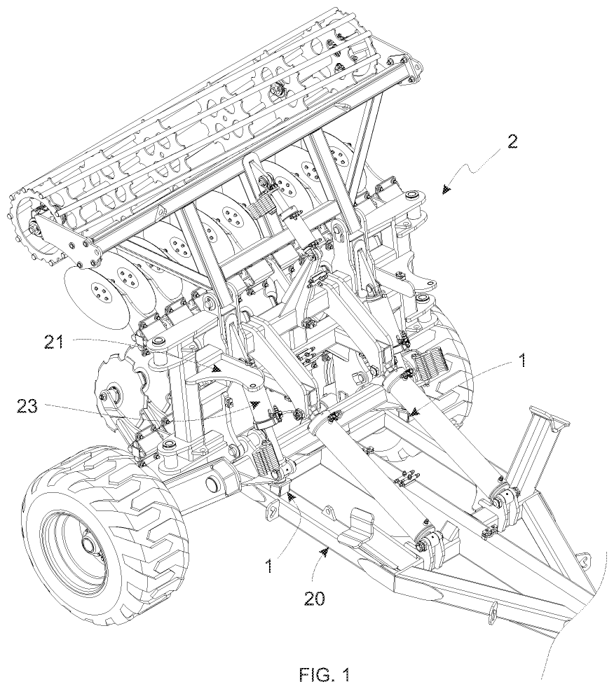

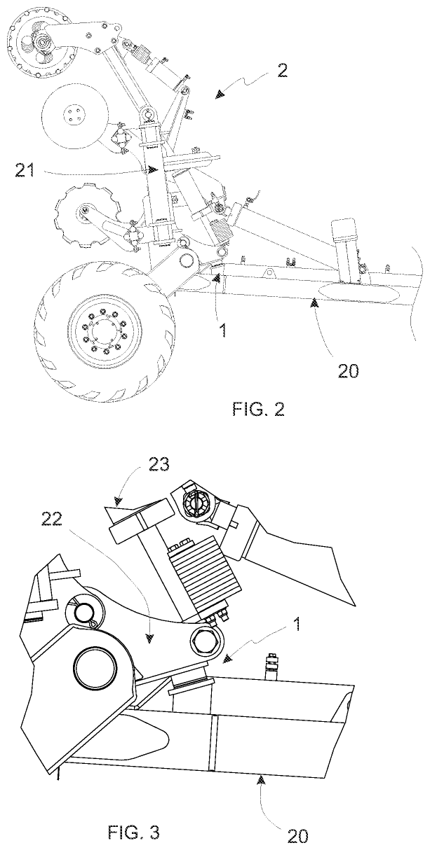

FIGS. 1 to 3 show the agricultural equipment 2 of the present invention in a preferred configuration, arranged in a transport position or configuration with its central section 21 disposed on the header 20 of the equipment 2, and provided with the supporting stop 1 of the present invention , also in a preferred setting.

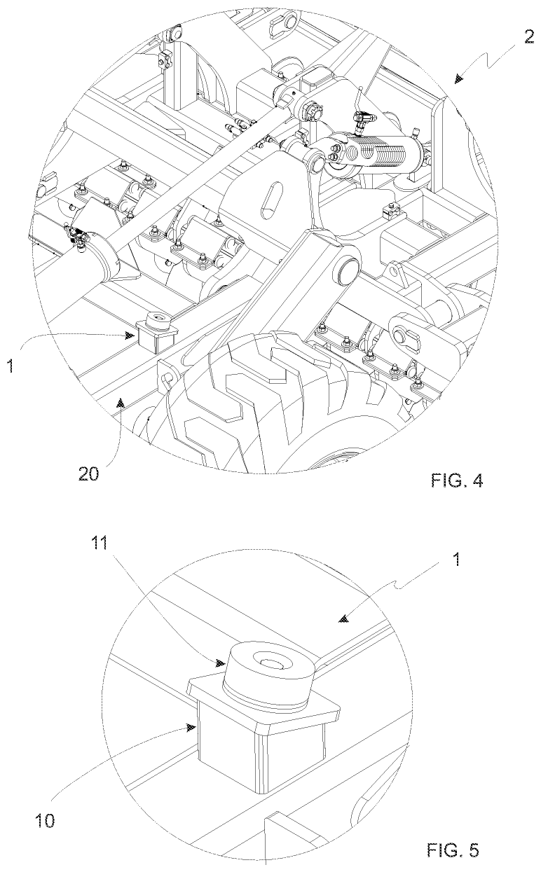

FIG. 4 reveals the equipment 2 in a working position or configuration, with the central section 21 open/hinged with respect to the header 20 of the equipment 2. FIG. 5 reveals a detail of FIG. 4 showing in more detail the supporting stop 1 of the present invention.

The supporting stop 1 comprises a supporting portion 10 to be secured to a first structural portion 20 of the agricultural equipment 2. The supporting portion 10 may be integrally secured to the first structural portion 20 of the apparatus 2, or it may be a separate element that is secured to the first structural portion 20 by any suitable means. The first structural portion 20 is a portion of the equipment 2 on which a second structural portion 21 of the equipment 2 rests at the time of its transport position. For example, the first structural portion 20 can be the header of the equipment, or, preferably, as seen in FIGS. 1 to 5, the first structural portion 20 can be one of the header beams. Furthermore, the supporting portion 10 can be understood as a rigid structural projection of the supporting stop 1, of any suitable geometric shape. The supporting portion may, in a possible embodiment, comprise an upper end angled with respect to the first structural portion 20 to ease the support of the second structural portion 21, for example, as best seen in FIG. 5.

The supporting stop 1 further comprises a damping portion 11 configured to contact a second structural portion 21 of the agricultural equipment 2. The damping portion 11 may be composed of a material of high impact absorption and dissipation capacity, preferably a flexible material such as rubber. The damping portion 11 may have any suitable shape, for example a cylindrical shape of reasonable height and diameter for adequate stress absorption. The structural portion 21 is preferably the central section or frame of the equipment 2, and more particularly a structural portion of the central section or frame which is positioned adjacent to the first structural portion 20 at the time of the transport position of the equipment 2. For example, in FIG. 3, it is observed that the second structural portion 21 comprises a hinge 22, which connects a cylinder 23 to the structure of the central section of the equipment 2. Therefore, in this preferred configuration, the hinge 22 itself rests on the supporting stop 1, and consequently the cylinder 23 also indirectly rests on said stop 1. More preferably, the second structural portion 21 is a cylinder end portion 23 or a frame directly connected to the cylinder end portion 23.

In this regard, the damping portion 11 is configured to contact the second structural portion 21 of the farm equipment 2 at the time of configuring the farm equipment 2, for a transport position. Therefore, at the time of moving the second structural portion 21 to a transport position of the equipment 2, it is supported on the damping portion 11 of the supporting stop 1 instead of directly resting on the first structural portion 20, thus allowing the absorption of impacts and vibrations that would otherwise be applied directly to cylinder 23, for example.

In this sense, the damping portion 11 is arranged on the supporting portion 10, so as to allow the direct contact of the damping portion 11 with the second structural portion 21 at the time of the transport position of the equipment 2. As already explained, the supporting portion 10 may comprise an angulation at its upper end, which translates into an angulation of the damping portion 11. The purpose of this angulation is to adequately support the second structural portion 21. In other words, since the transport position of the equipment 2 is configured by pivoting its central section in relation to its header, the second structural portion 21 will always approach the first structural portion 20 at a certain angle, which angle is compensated by the angulation of the damping portion 11.

Thus, the supporting stop 1 of the present invention is capable of absorbing and mitigating the impact and vibration efforts acting on the equipment 2 during its transport position, preventing such efforts from being directly transferred to the more sensitive elements of the equipment 2, such as, for example, the hydraulic cylinder 23. It is important to note that the support stop 1 of the present invention is easily implementable in any pre-existing agricultural equipment, since its fastening on a first structural portion 20 of the equipment 2 will be enough for its full functioning as proposed herein.

In accordance with the supporting stop 1 described herein, the present invention further provides for agricultural equipment 2 comprising a first and second structural portion 20, 21, the first structural portion 20 being provided with a supporting stop 1 as described above in any of its embodiments.

Said equipment 2 is configured to assume a working position and a transport position, the damping portion 11 being configured to contact a second structural portion 21 of the agricultural equipment 2 upon the assumption, by the agricultural equipment 2, of the transport position. As already explained, the first structural portion 20 of the equipment 2 can be a header or more particularly the header beams. The second structural portion 21, in turn, can be the central section or a portion of the central section of the equipment 2, where the second structural portion 21 is hinged or pivotally associated with the first structural portion 20.

Having described an example of preferred embodiment, it should be understood that the scope of the present invention encompasses other possible variations, being limited solely by the content of the appended claims, including possible equivalents therein.

1-8. (canceled)

9. A support stop (1) for agricultural equipment (2), said support stop (1) comprising:
a support portion (10) to be secured on a first structural portion (20) of the agricultural equipment (2); and
a damping portion (11) configured to contact a second structural portion (21) of the agricultural equipment (2).

10. The support stop (1) according to claim 9, wherein the damping portion (11) is configured to contact the second structural portion (21) of the agricultural equipment (2) at the time of the configuration, by the agricultural equipment (2), of a transport position.

11. The support stop (1) according to claim 9, wherein the damping portion (11) is arranged on the support portion (10).

12. The support stop (1) according to claim 9, wherein the support portion (10) is secured on the header (20) of the agricultural equipment (2).

13. Agricultural equipment (2) comprising:
a first and a second structural portion (20, 21), the first structural portion (20) being provided with a support stop (1),
wherein the support stop (1) comprises:
a support portion (10) to be fixed on a first structural portion (20) of the agricultural equipment (2); and
a damping portion (11) configured to contact a second structural portion (21) of the agricultural equipment (2).

14. The agricultural equipment (2) according to claim 13, wherein the equipment is configured to assume a working position and a transport position, the damping portion (11) being configured to contact a second structural portion (21) of the agricultural equipment (2) at the time of assuming, by the agricultural equipment (2), the transport position.

15. The agricultural equipment (2) according to claim 13, wherein the first structural portion (20) is a header.

16. The agricultural equipment (2) according to claim 15, wherein the second structural portion (21) is a central frame hingedly associated with the header.
